(19) United States
(12) Patent Application Publication
(10) Pub. No.: US 2020/0012300 A1
(43) Pub. Date: Jan. 9, 2020

(54) FILTER-INCLUDED ENERGY-SAVING LARGE-CAPACITY DIRECT-ACTING PRECISION PRESSURE REGULATION VALVE

(71) Applicant: TAIWAN CHELIC CORP., New Taipei City (TW)

(72) Inventors: Ping-Cheng Yu, New Taipei City (TW); Chih-Sheng Cheng, New Taipei City (TW)

(21) Appl. No.: 16/163,531

(22) Filed: Oct. 17, 2018

(30) Foreign Application Priority Data
Jul. 3, 2018 (TW) 107122864

(51) Int. Cl. G05D 16/10; F16K 31/122

(52) U.S. Cl. CPC G05D 16/106; F16K 31/1221

(57) ABSTRACT

A filter-included energy-saving large-capacity direct-acting precision pressure regulation valve includes a main body that is formed of a pressure regulation seat, a pressure regulation filter valve, and a protective cap arranged in sequence from top to bottom. The pressure regulation filter valve includes a main channel through which a primary side pressure and a secondary side pressure may flow. The main channel includes a primary valve port and a secondary valve port arranged therein for controlling and regulating the secondary side pressure and flow in a stage-wise manner. A flowrate straight rod assembly includes a straight rod fit to a pressure plunger ring. A straight rod spherical seat and a straight rod holder are coupled to an upper section of the straight rod and a secondary valve port spring supports a lower section of the straight rod. The pressure plunger ring is supported on a primary valve port the spring.

### (a) TECHNICAL FIELD OF THE INVENTION

The present invention relates to a filter-included energy-saving large-capacity direct-acting precision pressure regulation valve, which has a main body in which a pressure regulation filter valve having a primary valve port and a secondary valve port is arranged, such that when a pressure passes through the pressure regulation filter valve, a pressure regulating spring arranged in a pressure regulation seat regulates a pressing force applied to a flowrate straight rod assembly to allows a partial flow to first pass through the secondary valve port, and when an enlarged flow is desired to pass the valve, a primary valve port is opened, and also, a pressure differential between the primary valve port and the secondary valve port in opening and closing thereof being reduced to make the opening and closing of the primary valve port and the secondary valve port faster and more stable, and further a surface area of a primary diaphragm being made far larger than an area of the secondary valve port to achieve a purpose of precision regulation of pressure.

### (b) DESCRIPTION OF THE PRIOR ART

A known direct-acting precision pressure regulation valve (90) is shown in FIGS. 7 and 8, in which the direct-acting precision pressure regulation valve (90) is provided with an inlet terminal (PA) for ingress of a pressure fluid (PP) and an outlet terminal (PB) for egress, and a valve port (91) is arranged between the two terminals. The valve port (91) makes use of pressing forces applied by a diaphragm (93) and a spring (92) to control the consumption of the pressure fluid (PP) in the inlet terminal (PA) and a pressure and flowrate in the outlet terminal (PB).

The drawings show that a structure that functions to control the valve port (91) comprises a rod having an upper end receiving a spring force to apply thereon by a primary spring (94) to act on the diaphragm (93), in order to open the valve port (91), and a lower end that receives a spring force of a spring (92) for position returning and closing the valve port (91). It could be realized that in an operation of opening or closing the valve port (91), when a pressure of the outlet terminal (PB) is reduced by a minor amount, which can be multiplied by a difference between an area of the diaphragm (93) and an area of valve port (91) to provide a reduced amount of the acting force. The reduced amount, when divided by the spring constant of the primary spring (94), provides a displacement or deformation of the primary spring (94). With such an mount of displacement or deformation of the primary spring (94), the valve port (91) is opened, causing rise of the pressure of the outlet terminal (PB). Thus, for precise regulation and control of pressure, it needs to reduce the area of the valve port (91) and increase the displacement or deformation in order to achieve precise pressure regulation with minute loss of flow and pressure.

For the known direct-acting precision pressure regulation valve (90), considering the fact that reducing the area of the valve port (91) means reducing the available maximum flowrate, it is generally not adopted to reduce the area of the valve port (91). Prior art alternatively takes a measure of making an overflow orifice (96) in a normally open structure so that by consuming some air as being discharged to the surrounding atmosphere, the purpose of precision regulation of the output pressure can be achieved. This measure makes it necessary for the direct-acting precision pressure regulation valve (90) to waste some energy of a compressed air supply.

In brief, the structural arrangement of a flowrate straight rod assembly (95) of the valve port (91) makes it necessary for internal parts, such as the diaphragm (93) and the spring (92), of the direct-acting precision pressure regulation valve (90) to become enlarged in size corresponding to a need for an increased flowrate and this makes the size of the direct-acting precision pressure regulation valve (90) unlimitedly increased. And, as a consequence, the amount of air consumed at the overflow orifice (96) is also increased. As such, when a user carries out an operation of controlling and regulating, an increased amount of torque must be applied. Further, with the size of the valve port (91) so increased, even only an extremely small displacement is made for increasing a set pressure or for outputting a small flow, it is still possible that a large flow moves fast through the valve port (91) in a short period of time, making it hard to achieve fine controlling and leading to an even worse condition of unnecessary consumption and thus waste of air at the overflow orifice (96). Thus, it is desired to provide a device that overcomes such problems.

### SUMMARY OF THE INVENTION

The present invention relates to a filter-included energy-saving large-capacity direct-acting precision pressure regulation valve, of which a technical purpose uses a flowrate straight rod assembly in combination with a primary diaphragm and primary and secondary valve port springs applying forces at two ends to allow a primary valve port and a secondary valve port to open/close in a stage-wise manner according to flowrate requirement and to reduce unnecessary waste of flow, and the secondary valve port allowing for easy control of minute flow and precision regulation and setting of pressure, wherein when the size of the primary valve port is increased to accommodate an increase of flowrate, the secondary valve port does not need to be increased in respect of the size thereof so that the large-capacity direct-acting precision pressure reduction valve may achieve the purpose of precision pressure output.

A secondary technical purpose is to provide a two-stage opening/closing valve structure, which allows a change of flowrate from a small level to a large level is made to correspond the opening/closing of the corresponding valve gates, so that a pressure differential between a primary side pressure and a secondary side pressure can be reduced to make the control and regulation of output pressure easy and also to allow for performance of more precise regulation of pressure, and also to prevent influence on the speed of opening/closing.

A further technical purpose is to provide a two-stage opening structural arrangement of a flowrate straight rod assembly and primary and secondary valve ports in order to avoid unnecessary increase of sizes of parts of the flowrate straight rod assembly that occupies interior space of the structural arrangement and thus keep the size of a main body the same, without the need to increase the size of the main body to accommodate an increased flowrate and also without the need to increase the sizes of a pressure regulation seat and a pressure regulation knob that are provided for the pressure regulation, whereby the torque that a user applies in turning a pressure regulation axle can be reduced and a primary spring can be more easily compressed to drive a primary diaphragm for providing a desired pressure output.

The filter-included energy-saving large-capacity direct-acting precision pressure regulation valve according to the present invention comprises a main body that is formed of a pressure regulation seat, a pressure regulation filter valve, and a protective cap that are connected with each other in sequence from top to bottom. The pressure regulation filter valve is formed with a main channel through which a primary side pressure and a secondary side pressure may be in fluid connection with and in communication with each other. The main channel is provided in an interior thereof with a primary valve port and a secondary valve port, so as to provide stage-wise regulation of flow into the secondary side pressure. A flowrate straight rod assembly comprises a straight rod that receives a pressure plunger ring to fit thereto. A straight rod spherical seat is coupled to an upper section or a top of the straight rod. The straight rod is supported, on a lower section or a bottom thereof, by a secondary valve port spring. The pressure plunger ring is provided on an underside thereof with a primary valve port the spring abutting thereon so that the pressure plunger ring is displaceable to carry out opening/closing operation of the primary valve port. The straight rod spherical seat is subjected to application of force thereto by a primary diaphragm arranged in the pressure regulation seat so that the main body is operable to first allow a partial flow and a partial pressure to flow through the secondary valve port. With an increase of a pressing force applied by the primary diaphragm for regulation purposes, the flowrate straight rod assembly opens the primary valve port to allow an enlarged flow to pass through the primary valve port and the secondary valve port. This invention makes a pressure differential in opening/closing between the primary valve port and the secondary valve port to make opening/closing of the primary valve port and the second valve port faster and more stable and also to achieve the purposes of precision pressure regulation and saving energy

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional view showing a structure of the present invention in a standby condition.

FIG. 2A is a cross-sectional view, in an exploded form, illustrating a flowrate straight rod of the present invention.

FIG. 2B is a cross-sectional view, in an assembled form, illustrating the flowrate straight rod of the present invention.

FIG. 3 is a cross-sectional view illustrating a secondary valve port of the present invention in a working condition.

FIG. 4 is a cross-sectional view, in an enlarged form, illustrating a portion of the secondary valve port of the present invention in the working condition.

FIG. 5 is a cross-sectional view illustrating a primary valve port of the present invention in a working condition.

FIG. 6 is a cross-sectional view, in an enlarged form, illustrating a portion of the primary valve port of the present invention in the working condition.

FIG. 7 is a schematic view illustrating a structure of prior art.

FIG. 8 is a schematic view illustrating the structure of the prior art in a working condition.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

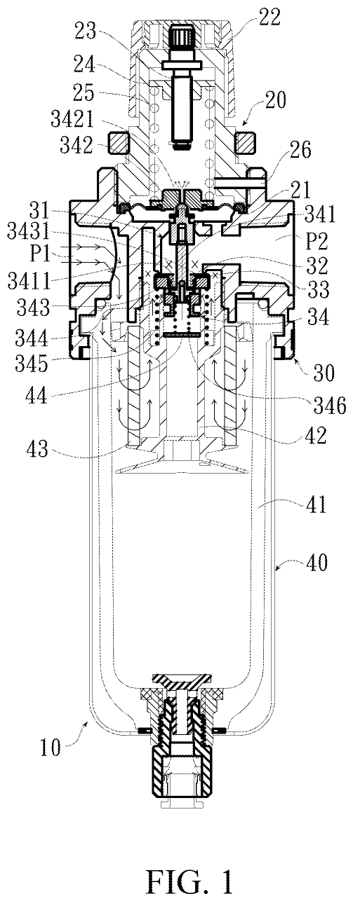

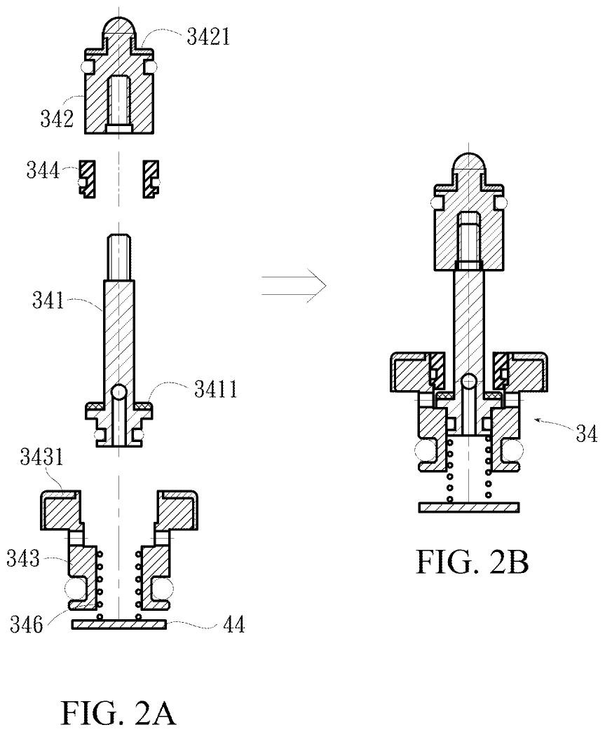

The present invention can be better understood with a detailed description, as provided below, for illustrating the best feasible embodiment of the present invention, with reference to FIGS. 1 and 2 of the attached drawings.

The present invention provides a filter-included energy-saving large-capacity direct-acting precision pressure regulation valve, which has a structure that comprises: a main body (10), which is formed of a pressure regulation seat (20), a pressure regulation filter valve (30), and a protective cap (40) that are connected to each other in sequence from top to bottom. The protective cap (40) is provided, in an interior thereof, with a plastic cup (41), and the plastic cup (41) receives a filter core seat (42) to locate therein. The filter core seat (42) is provided thereon with a replaceable filter core (43), and the filter core seat (42) is also provided therein with a bottom board (dip.

The pressure regulation filter valve (30) is formed therein with a main channel (31) that allows a primary side pressure (P1) and a secondary side pressure (P2) to be in fluid connection with and in communication with each other. The main channel (31) is provided in an interior thereof with a primary valve port (32) and a secondary valve port (33) that is arranged in an interior of the primary valve port (32) so as to provide stage-wise control of a flow moving into the secondary side pressure (P2). The secondary valve port (33) is provided, on an underside thereof, with a secondary valve port spring (346), which provides a spring force to close the secondary valve port (33) and thus, providing the secondary valve port (33) with a spring-based returning function. The secondary valve port spring (346) has a spring constant that is as small as possible in order to provide precision regulation and control of an output pressure.

Also provided is a flowrate straight rod assembly (34), which is formed of a straight rod (341) that receives a pressure plunger ring (343) to fit thereon. Specifically, after the pressure plunger ring (343) has been so fit, there is a space that allows for a first stage of minimum displacement to carry out. The first stage of displacement is carried out for just around 0.3 to 0.1 millimeters, to allow a second stage of displacement to be subsequently carried out as early as possible in order to provide an enlarged output of flow.

The straight rod (341) is connected, at a top thereof, to a straight rod spherical seat (342) and is also coupled to a straight rod holder (344); the straight rod (341) is supported, at a bottom thereof, on a secondary valve port spring (346) as being abutted thereby. The pressure plunger ring (343) is provided, on an underside thereof, with a primary valve port the spring (345) abutting thereon so that the pressure plunger ring (343) is elastically biased for displacement to open/close the primary valve port (32). The straight rod spherical seat (342) is subjected to application of pressure thereto by a primary diaphragm (21) and a primary spring (25) arranged in the pressure regulation seat (20) so that the main body (10) may first allow a partial flowrate and partial pressure to flow through the secondary valve port (33), during which time precision pressure regulation can be conducted in respect of a set pressure. And, this can be done in such a manner that an overflow orifice (26) requires on air or gas to be consumed thereby as being discharged to the surrounding atmosphere. With an increase of the pressing force applied by the primary diaphragm (21) as a consequence of the regulation operation, the flowrate straight rod assembly (34) may open the primary valve port (32), so that as simultaneously moving through the primary valve port (32) and the secondary valve port (33), an enlarged flow is provided.

As shown in FIG. 2, the flowrate straight rod assembly (34) is structured such that the straight rod (341) is covered by a straight rod elastic enclosure (3411), and the straight rod spherical seat (342) is also covered, on a surface thereof, with a spherical seat elastic enclosure (3421). Additional reference being had to FIG. 1, it can be understood that the straight rod elastic enclosure (3411) is provided on a surface that is contactable with a bottom of the straight rod holder (344) for opening/closing the secondary valve port (33). The pressure plunger ring (343) is also provided with a pressure plunger ring elastic enclosure (3431) for opening/closing the primary valve port (32). The spherical seat elastic enclosure (3421) is provided to improve sealing engagement thereof with the primary diaphragm (21) through contacting therebetween for closing or opening to allow the secondary side pressure (P2) in the pressure regulation filter valve (30) to move in and out for adjusting accuracy of regulation of the secondary side pressure (P2). Thus, it can be seen that the flowrate straight rod assembly (34) is formed of a two-staged structural arrangement to better control and regulation of flowing of the secondary side pressure (P2).

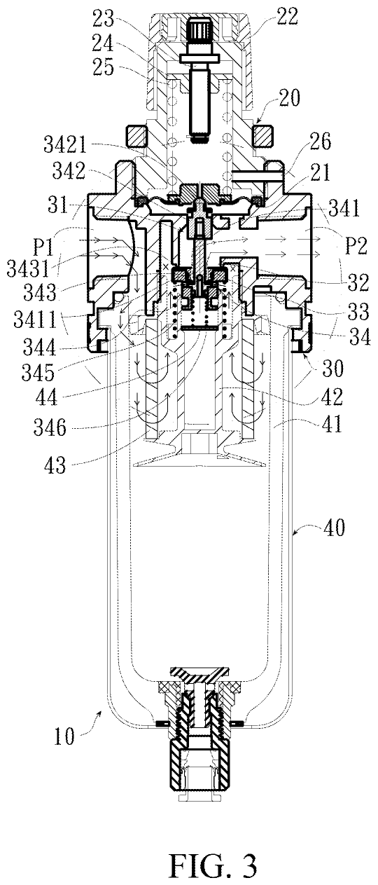

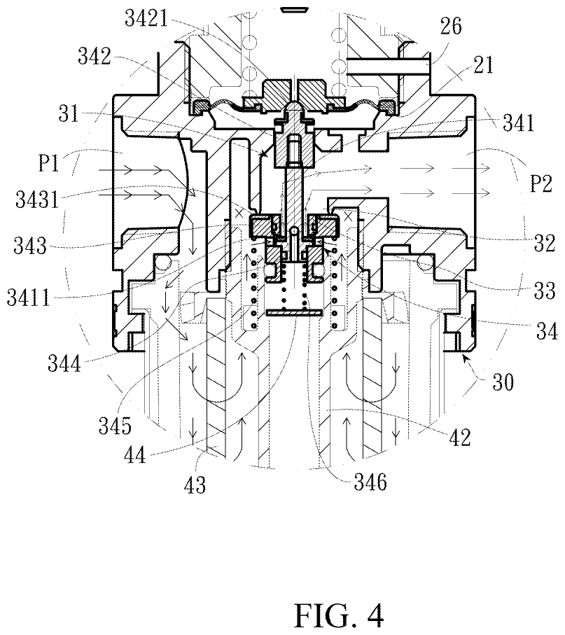

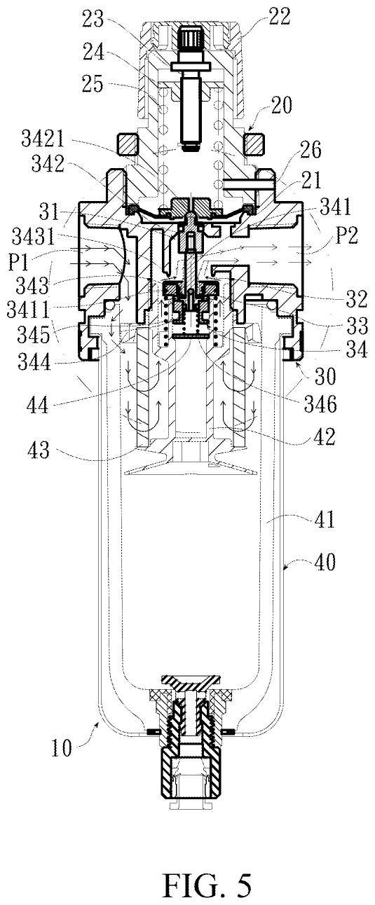

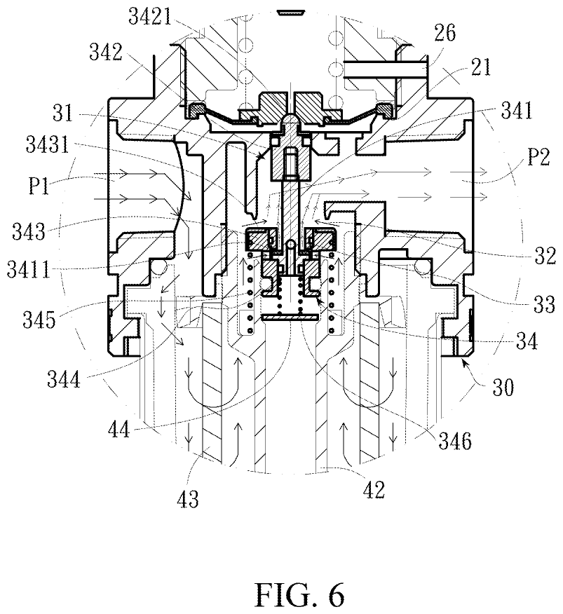

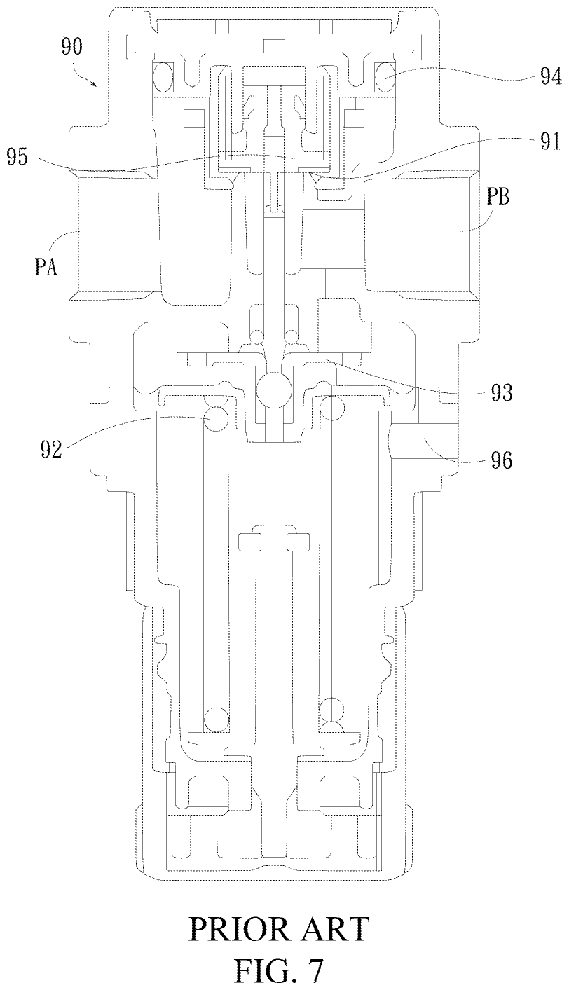

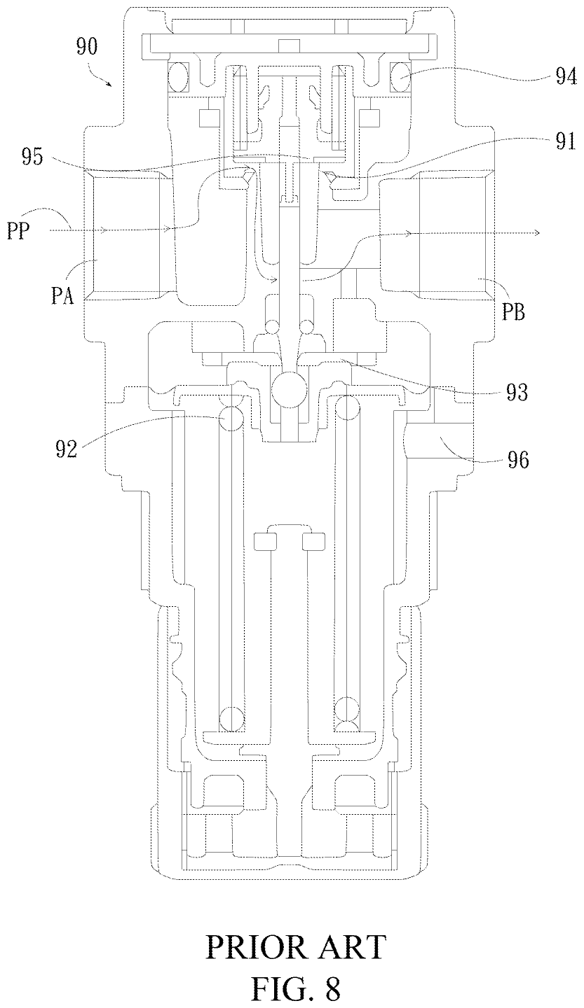

Referring to FIGS. 3 and 4, when the primary side pressure (P1) moves along the main channel (31) by passing through the secondary valve port (33), the flowrate straight rod assembly (34) undergoes only the first stage displacement, where the primary diaphragm (21) is initially pushed downward and flowrate required for operation of the main body (10) does not reach the maximum level. Further referring to FIGS. 5 and 6, when the flowrate straight rod assembly (34) is further pushed downward by the primary diaphragm (21), the pressure plunger ring (343) is also caused by the straight rod (341) to move downward to additionally carry out the second stage displacement, and thus opening the primary valve port (32), where the flowrate can be allowed to move through the main body (10) at the maximum level.

In the illustration of the drawings of the present invention, it can be seen that an overflow orifice (26) is arranged at a lateral side of the pressure regulation seat (20) and is a normally closed arrangement so that when a flow passes through the main channel (31), no air or gas is consumed through or by the overflow orifice (26). Therefore, the main body (10) could achieve an excellent effect of saving energy. In addition, regarding internal structure, this invention is similar to the prior art, except the flowrate straight rod assembly (34) and the primary and secondary valve ports (32, 33) are of different structures, the other components are almost the same and can be shared between the two, so that direct replacement or substitute can be made to adopt the stage-wise valve port arrangement according to the present invention, in order to improve the flowrate without the need to make any modification or change to the overall size of the main body (10) and thus, cost and time required to fabricate new molds for new manufacturing operations can be saved. In addition, it can be learnt from the above that in opening and closing the primary valve port (32) and the secondary valve port (33), by means of reducing the surface area of the secondary valve port (33) to a minimum area, while keeping the surface area of the primary valve port (32) the same, under the condition that the accuracy of pressure regulation is generally commeasurable to the condition of flow and pressure required by the prior art structure, this invention could reduce loss to an even lower level, while capable of achieving accurate and precise pressure regulation.

In summary, the present invention provides a filter-included energy-saving large-capacity direct-acting precision pressure regulation valve, which provides a flowrate straight rod assembly (34) that involves a structural arrangement for opening/closing a primary valve port (32) and a secondary valve port (33) in a two-stage manner to respectively suit the needs for regular flowrate and large flowrate, whereby besides an increase can be made on an overall flow passing therethrough, a response speed of the device can also be enhanced, and in addition, pressure differential between a primary side pressure (P1) and a secondary side pressure (P2) can be reduced to allow a user to conduct control in a effort-saving and easy manner, so that an effect of precision regulation of pressure can be achieved and application to a valve port of an increased size can be done by changing the two-stage structure of the valve port to a more-stage structure. This could overcome the drawback of the prior art that an increase of capacity requires a corresponding increase of the parts, and also makes control and use easier.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A filter-included energy-saving large-capacity direct-acting precision pressure regulation valve, comprising:
main body, which is formed of a pressure regulation seat, a pressure regulation filter valve, and a protective cap that are connected with each other in sequence from top to bottom, the pressure regulation filter valve being formed therein with a main channel that allows a primary side pressure and a secondary side pressure to be in fluid connection with and in communication with each other, the main channel being provided in an interior thereof with a primary valve port and a secondary valve port arranged in an interior of the primary valve port to provide stage-wise regulation of flow into the secondary side pressure, wherein a flowrate straight rod assembly comprises a straight rod, that receives a pressure plunger ring to fit thereto, a straight rod spherical seat and a straight rod holder being coupled to an upper stage of the straight rod, a lower stage of the straight rod being abutted by and supported on a secondary valve port spring, the pressure plunger ring being provided on an underside thereof with a primary valve port the spring abutting thereon so that the pressure plunger ring is displaceable for opening/closing the primary valve port, the straight rod spherical seat being subjected to application of pressure thereto by a primary diaphragm arranged in the pressure regulation seat so that the main body is operable to first allow a partial flow and a partial pressure to flow through the secondary valve port to thereby achieve pressure setting and precision pressure regulation at the same time, while no consumption of gas at an overflow orifice formed at a lateral side of the pressure regulation seat by discharging gas to a surrounding atmosphere, wherein with an increase of a pressing force applied by the primary diaphragm for regulation purposes, the flowrate straight rod assembly opens the primary valve port to allow an enlarged flow to pass through both the primary valve port and the secondary valve port.

2. The filter-included energy-saving large-capacity direct-acting precision pressure regulation valve according to claim 1, wherein the flowrate straight rod assembly comprises a stage-wise structural arrangement so that the primary valve port and the secondary valve port are openable in a consecutive manner.

3. The filter-included energy-saving large-capacity direct-acting precision pressure regulation valve according to claim 2, wherein the stage-wise structural arrangement of the flowrate straight rod assembly includes at least two stages, wherein a first stage of minimum displacement is carried out for 0.3 to 0.1 millimeters so that a second stage displacement is subsequently carried out as early as possible to provide the enlarged flow output.

4. The filter-included energy-saving large-capacity direct-acting precision pressure regulation valve according to claim 1, wherein the straight rod also comprises a straight rod elastic enclosure that covers a surface of the straight rod and is contactable with a bottom of the straight rod holder to improve sealing of the secondary valve port.

5. The filter-included energy-saving large-capacity direct-acting precision pressure regulation valve according to claim 1, wherein the straight rod spherical seat also comprises a spherical seat elastic enclosure, which covers a surface of the straight rod spherical seat to improve sealing through contact with the primary diaphragm.
